(19) United States
(12) Patent Application Publication
(10) Pub. No.: US 2005/0078832 A1
(43) Pub. Date: Apr. 14, 2005

(54) Parametric audio coding

(76) Inventors: Steven Leonardus Josephus Dimphina Elisabeth Van De Par, Eindhoven (NL); Armin Gerhard Kohlrausch, Eindhoven (NL); Albertus Cornelis Den Brinker, Eindhoven (NL); Erik Gosuinus Petrus Schuijers, Eindhoven (NL); Nicolle Hanneke Van Schijndel, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/504,658

(22) PCT Filed: Jan. 17, 2003
(86) PCT No.: PCT/IB03/00108

(30) Foreign Application Priority Data
Feb. 18, 2002 (EP) 02075639.1

(51) Int. Cl. H04R 5/00

(52) U.S. Cl. 381/17

(57) ABSTRACT

The invention provides coding (11) of an at least two-channel audio signal (L,R) by determining common frequencies (f_{com}) in the at least two channels (L,R) of the audio signal, which common frequencies occur in at least two of the at least two channels of the audio signal, and by representing respective sinusoidal components in respective channels at a given common frequency by a representation of the given common frequency (f_{com}) and a representation of respective amplitudes (A,ΔA) of the respective sinusoidal components at the given common frequency.

The invention relates to parametric audio coding.

Heiko Purnhagen, ‘Advances in parametric audio coding’, Proc. 1999 IEEE Workshop on Applications of Signal Processing to Audio and Acoustics, New Paltz, N.Y., Oct. 17-20, 1999 discloses that parametric modeling provides an efficient representation of general audio signals and is utilized in very low bit rate audio coding. It is based on the decomposition of an audio signal into components which are described by appropriate source models and represented by model parameters (like the frequency and amplitude of a pure tone). Perception models are utilized in signal decomposition and model parameter coding.

An object of the invention is to provide an advantageous parameterization of a multi-channel (e.g. stereo) audio signal. To this end, the invention provides a method of encoding, an encoder, an apparatus, an encoded audio signal, a storage medium, a method of decoding, a decoder and a receiver or reproduction apparatus as defined in the independent claims. Advantageous embodiments are defined in the dependent claims.

It is noted that stereo audio coding as such is known in the prior art. For example, the two channels left (L) and right (R) may be coded independently. This may be done by two independent encoders arranged in parallel or by time multiplexing in one encoder. Usually, one can code the two channels more efficiently by using cross-channel correlation (and irrelevancies) in the signal. Reference is made to the MPEG-2 audio standard (ISO/IEC 13818-3, pages 5, 6) which discloses joint stereo coding. Joint stereo coding exploits the redundancy between left and right channels in order to reduce the audio bit-rate. Two forms of joint stereo coding are possible: MS stereo and intensity stereo. MS stereo is based on coding the sum (L+R) and the difference (L−R) signal instead of the left (L) and right (R) channels. Intensity coding is based on retaining at high frequencies only the energy envelope of the right (R) and left (L) channels. Direct application of the MS stereo coding principle in parametric coding instead of in subband coding would result in a parameterized sum signal and a parameterized difference signal. The forming of the sum signal and the difference signal before encoding might give rise to the generation of additional frequency components in the audio signal to be encoded which reduces the efficiency of the parametric coding. Direct application of the intensity stereo coding principle on a parametric coding scheme would result in a low frequency part with independently encoded channels and a high frequency part that includes only the energy envelope of the right and left channels.

According to a first aspect of the invention, common frequencies are determined in the at least two channels of the audio signal, which common frequencies occur in at least two of the at least two channels, and respective sinusoidal components in respective channels at a given common frequency are represented by a representation of the given common frequency, and a representation of respective amplitudes of the respective sinusoidal components at the given common frequency. This aspect is based on the insight that a given frequency generated by a given source has a high probability to have a component in each of the channels. These signal components will have their frequency in common. This is true because signal transformations that may occur in the transmission from sound source via recording equipment to the listener will usually not affect frequency components differentially in the various or all channels. Thus, common components in the various signal channels can be represented by a single, common frequency. The respective amplitudes (and phases) of the respective components in the respective channels may differ. Thus, by coding the sinusoids with a common frequency and a representation of the respective amplitudes, an efficient compressive coding of the audio signal is achieved; only one parameter is needed to encode a given common frequency (which occurs in various channels). Further, such a parameterization is advantageously applied with a suitable psycho-acoustic model.

Once a common frequency has been found, the other parameters describing the components in each respective channel can be represented. For example, for a stereo signal that is represented with sinusoidal components, the mean and the difference of the amplitudes (and optionally the respective phases) can be coded. In a further embodiment, the largest amplitude is encoded in the coded audio stream together with a difference amplitude, wherein the sign of the difference amplitude may determine the dominant channel for this frequency.

Since there is likely to be some degree of correlation between the left and the right channels, entropy coding of the sinusoidal parameters can be used which will result in more efficient encoding of the stereo signal. In addition, irrelevant information within the common component representation can be removed, e.g. interaural phase differences at high frequencies are inaudible and can be set to zero.

It is possible to encode any frequency occurring in the channels as a common frequency. If a frequency occurring in one channel does not occur in another channel, the amplitude representation should then be encoded such as to result in a zero amplitude for the channel in which the frequency does not occur. For example if in a multi-channel application a frequency occurs in 3 of the 4 channels, then the frequency can be encoded as a common frequency while making the amplitude zero in the channel in which the frequency does not occur.

Non-common frequencies may also be represented as independent sinusoids in the respective channels. Non-common frequencies can be encoded in a separate parameter block. It is further possible to produce a first parameter block including common frequencies which common frequencies are common to all channels, a second parameter block which includes frequencies which are common to a (predetermined) subset of all channels, a third parameter block which includes frequencies which are common to a further (predetermined) subset of all channels, and so on until a last parameter block which includes the frequencies which occur in only one channel and which are independently coded.

A common frequency may be represented as an absolute frequency value but also as a frequency changing over time, e.g. a first derivative ∂f/∂t. Further, the common frequencies may be differentially encoded relative to other common frequencies.

Common frequencies can be found by estimating frequencies by considering two or more channels at the same time.

In a first embodiment, frequencies are separately determined for the respective channels followed by a comparison step to determine the common frequencies. The determination of the frequencies occurring in the respective channels may be performed by a conventional matching pursuit (see e.g. S. G. Mallat and Z. Zhang, “Matching pursuits with time-frequency dictionaries,” IEEE trans. on Signal Processing, vol. 41, no. 12, pp. 3397-3415) or peak picking (see e.g. 'R. McAulay and T. Quatieri, “Speech Analysis/Synthesis Based on a Sinusoidal Representation,” IEEE Trans. ASSP, Vol. 34, No. 4, pp. 744-754, August 1986).

In a second embodiment for determining the common frequencies, a combined matching pursuit algorithm is employed. For example, respective power or energy representations of the at least two channels are combined to obtain a common representation. The common frequencies are then determined based on the common representation. Preferably, the power spectra of the at least two channels are added to obtain a common power spectrum. A conventional matching pursuit is used to determine the frequencies in this added spectrum. The frequencies found in this added power spectrum are determined to be common frequencies.

In a third embodiment for determining the common frequencies, peak picking in added power spectra is used. The frequencies of the maxima that are found in this common power spectrum can be used as the common frequencies. One could also add log-power spectra instead of linear power spectra.

Preferably, the phase of the respective components of the common frequency is also encoded. A common phase, which may be the average phase of the phases in the channels or the phase of the channel with the largest amplitude, and a difference phase (inter-channel) may be included in the coded audio signal. Advantageously, the difference phase is only encoded up to a given threshold frequency (e.g. 1.5 kHz or 2 kHz). For frequencies higher than this threshold, no difference phase is encoded. This is possible without reducing the quality significantly, because human sensitivity to interaural phase differences is low for frequencies above this threshold. Therefore, a difference phase parameter is not necessary for frequencies above the given threshold. Upon decoding, the delta phase parameter can be assumed to be zero for frequencies above the threshold. The decoder is arranged to receive such signals. Above the threshold frequency the decoder does not expect any codes for difference phases. Because the difference phases are in practical embodiment not provided with an identifier, it is important for the decoder to know when to expect difference phases and when not. Further, because the human ear is less sensitive to large interaural intensity differences, delta amplitudes which are larger than a certain threshold, e.g. 10 dB, can be assumed infinite. Consequently, also in this case no interaural phase differences need to be encoded.

Frequencies in different channels differing less than a given threshold may be represented by a common frequency. In this case it is assumed that the differing frequencies originate from the same source frequency. In practical embodiments, the threshold is related to the accuracy of the matching pursuit or peak-picking algorithm.

In practical embodiments, the parameterization according to the invention is employed on frame-basis.

The invention is applicable to any audio signal, including speech signals.

These and other aspects of the invention will be apparent from the elucidated with reference to the accompanying drawings.

In the drawings:

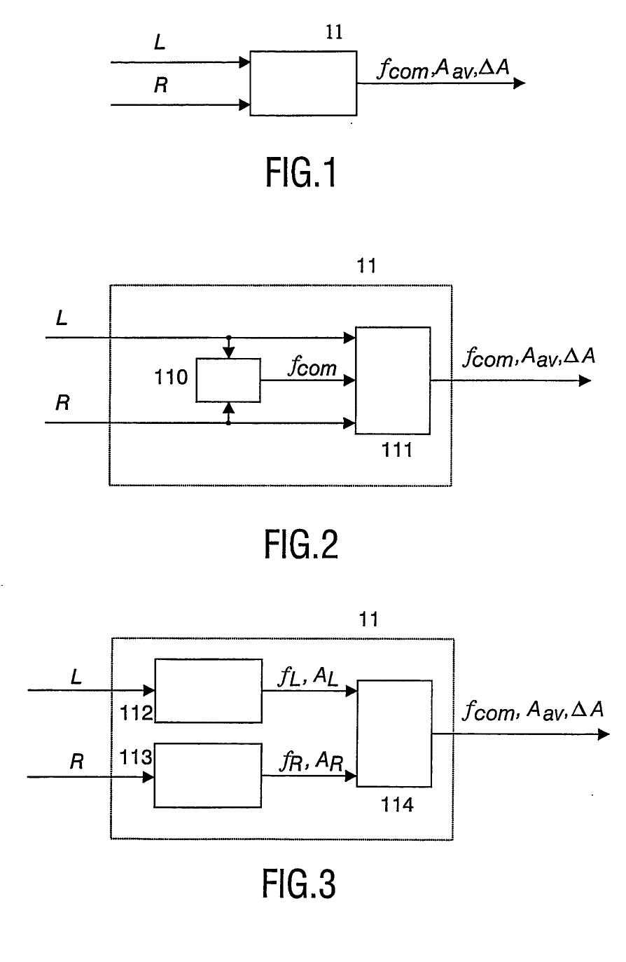

FIG. 1 shows an encoder according to an embodiment of the invention;

FIG. 2 shows a possible implementation of the encoder of FIG. 1;

FIG. 3 shows an alternative implementation of the encoder of FIG. 1, and

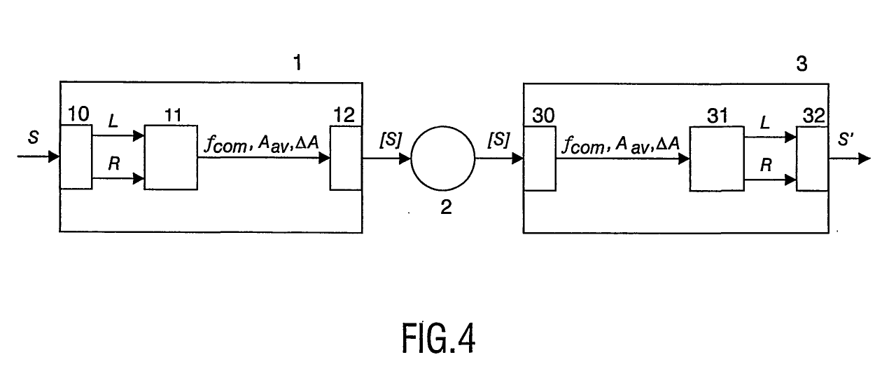

FIG. 4 shows a system according to an embodiment of the invention.

The drawings only show those elements that are necessary to understand the embodiments of the invention.

FIG. 1 shows an encoder 11 according to an embodiment of the invention. A multi-channel audio signal is input to the encoder. In this embodiment the multi-channel audio signal is a stereo audio signal having a left channel L and a right channel R. The encoder 11 has two inputs: one input for the left channel signal L and another input for the right channel signal R. Alternatively, the encoder has one input for both channels L and R which are in that case furnished in a multiplexed form to the encoder 11. The encoder 11 extracts sinusoids from both channels and determines common frequencies f_{com}. The result of the encoding process performed in the encoder 11 is an encoded audio signal. The encoded audio signal includes the common frequencies f_{com} and per common frequency f_{com} a representation of the respective amplitudes in the respective channels, e.g. in the form of a maximum or average amplitude A and a difference (delta) amplitude ΔA.

In the following, it is described how the common frequencies may be determined, a first embodiment employing a matching pursuit and second embodiment employing peak-picking.

An Embodiment Employing ‘Matching Pursuit’

This method is an extension of existing matching pursuit algorithms. Matching pursuits are well-known in the art. A matching pursuit is an iterative algorithm. It projects the signal onto a matching dictionary element chosen from a redundant dictionary of time-frequency waveforms. The projection is subtracted from the signal to be approximated in the next iteration. Thus in existing matching pursuit algorithms, the parameterization is performed by iteratively determining a peak of the ‘projected’ power spectrum of a frame of the audio signal, deriving the optimal amplitude and phase corresponding to the peak frequency, and extracting the corresponding sinusoid from the frame under analysis. This process is iteratively repeated until a satisfactory parameterization of the audio signal is obtained. To derive common frequencies in a multi-channel audio signal, the power spectra of the left and right channels are added and the peaks of this sum power spectrum are determined. These peak frequencies are used to determine the optimal amplitudes and optionally the phases of the left and the right (or more) channels.

The multi-channel matching pursuit algorithm according to a practical embodiment of the invention comprises the step of splitting the multi-channel signal into short-duration (e.g. 10 ms) overlapping frames, and applying iteratively the following steps on each of the frames until a stop criterion has been met:
1. The power spectra of each of the channels of the multi-channel frame are calculated
2. The power spectra are added to obtain a common power spectrum
3. The frequency at which the common ‘projected’ power spectrum is maximum is determined
4. For the frequency determined in step 3, for each channel, the amplitude and phase of the best matching sinusoid are determined and all these parameters are stored. These parameters are encoded using the common frequencies in combination with a representation of the respective amplitudes thereby exploiting cross-channel correlations and irrelevancies.
5. The sinusoids are subtracted from the corresponding current multi-channel frames to obtain an updated residual signal which serves as the next multi-channel frame in step 1.
   Embodiment Using ‘Peak Picking’

Alternatively, peak picking may be used, e.g. including the following steps:
1. The power spectra of each of the channels of the multi-channel frame are calculated
2. The power spectra are added to obtain a common power spectrum
3. The frequencies corresponding to all peaks within the power spectrum are determined
4. For these determined frequencies, the best amplitudes and best phases are obtained

FIG. 2 shows a possible implementation of the encoder of FIG. 1, which makes use of a common (added) power spectrum of the channels to determine the common frequencies. In calculation unit 110 a matching pursuit process or a peak picking process is performed as described above by using a common power spectrum obtained from the L and R channels. The determined common frequencies f_{com} are furnished to coding unit 111. This coding unit determines the respective amplitudes of the sinusoids (and preferably the phases) in the various channels at a given common frequency.

Alternatively, the respective channels are independently encoded to obtain a set of parameterized sinusoids for each channel. These parameters are thereafter checked for common frequencies. Such an embodiment is shown in FIG. 3. FIG. 3 shows an alternative implementation of the encoder 11 of FIG. 1. In this implementation, the encoder 11 comprises two independent parametric encoders 112 and 113. The parameters f_{L}, A_{L} and f_{R}, A_{R} obtained in these independent coders are furnished to a further coding unit 114 which determines the common frequencies f_{com} in these two parameterized signals.

Example of Coding a Stereo Audio Signal

Assume that a stereo audio signal is given with the following characteristics:

| channel | f (Hz) | A (dB) | f (Hz) | A (dB) | f (Hz) | A (dB) | f (Hz) | A (dB) | f (Hz) | A (dB) |
|---|---|---|---|---|---|---|---|---|---|---|
| L | 50 | 30 | 100 | 50 | 250 | 40 | — | — | 500 | 40 |
| R | 50 | 20 | 100 | 60 | — | — | 200 | 30 | 500 | 35 |

In practice, in the case the amplitude difference between the channels is +15 dB or −15 dB at a given frequency, this frequency is considered to occur only in the dominant channel.

Independently Coded

The following parameterization can be used to code the exemplary stereo signal independently.
L(f,A)=(50,30), (100,50), (250,40), (500,40)
R(f,A)=(50,20), (100,60), (200,30), (500,35).

This parameterization requires 16 parameters.

Using Common Frequencies and Non-Common Frequencies

Common frequencies are 50 Hz, 100 Hz and 500 Hz. To code this signal:
(F_{com},Aₘₐₓ, ΔA)=(50,30,10), (100,60,−10), (500,40,5)
(F_{non-com},A)=(200,−30), (250,40).

Coding the exemplary stereo audio signal using common and non-common frequencies requires 13 parameters in this example. Compared to the independently coded multi-channel signal, the use of common frequencies reduces the number of coding parameters. Further, the values for the delta amplitude are smaller than for the absolute amplitudes as given in the independently coded multi-channel signal. This further reduces the bit-rate.

The sign in the delta amplitude ΔA determines the dominant channel (between two signals). In the above example, a positive amplitude means that the left channel is dominant. The sign can also be used in the non-common frequency representation to indicate for which signal the frequency is valid. Same convention is used here: positive is left (dominant). It is alternatively possible to give an average amplitude in combination with a difference amplitude, or consistently the amplitude of a given channel with a difference amplitude relative to the other channel.

Instead of using the sign in the delta amplitude ΔA to determine the dominant channel, it is also possible to use a bit in the bit-stream to indicate the dominant channel. This requires 1 bit as may also be the case for the sign bit. This bit is included in the bit-stream and used in the decoder. In the case that an audio signal is encoded with more than two channels, more than 1 bit is needed to indicate the dominant channel. This implementation is straightforward.

Use of Only Common Frequencies

When only a representation based on common frequencies is used, the non-common frequencies are coded such that the amplitude of the common frequency in the channel in which no sinusoid occurs at that frequency is zero. In practice, a value of e.g. +15 dB or −15 dB for the delta amplitude can be used to indicate that no sinusoid of the current frequency is present in the given channel. The sign in the delta amplitude ΔA determines the dominant channel (between two signals). In this example, a positive amplitude means that the left charnel is dominant.
(F_{com},A, ΔA)=(50,30,10), (100,60,−10), (200,30,−15), (250,40,15), (500,40,5).

This parameterization requires 15 parameters. For this example, the use of only common frequencies is less advantageous than the use of common and non-common frequencies.

Frequency Average and Differences

(Fₐᵥ, ΔF,Aₐᵥ, ΔA)=(50,0,25,5), (100,0,55,−5), (225,25,35,5), (500,0,30,10).

This parameterization requires 16 parameters.

This is an alternative encoding wherein the sinusoidal components in the signal are represented by average frequencies and average amplitudes. It is clear that also compared with this coding strategy, the use of common frequencies is advantageous. It is noted that the use of average frequencies and average amplitudes can be seen as a separate invention outside the scope of the current application.

It is noted that not strictly the number of parameters but rather the sum of the number of bits per parameter is of importance for the bit-rate of the resulting coded audio stream. In this respect, differential coding usually provides a bit-rate reduction for correlated signal components.

The representation with a common frequency parameter and respective amplitudes (and optionally respective phases) can be regarded as a mono representation, captured in the parameters common frequency, average or maximum amplitude, phase of the average or maximum amplitude (optional) and a multi-channel extension captured in the parameters delta amplitude and delta phase (optional). The mono parameters can be treated as standard parameters that one would get in a mono sinusoidal encoder. Thus, these mono parameters can be used to create links between sinusoids in subsequent frames, to encode parameters differentially according to these links and to perform phase continuation. The additional, multi-channel parameters can be encoded according to strategies mentioned above which further exploit binaural hearing properties. The delta parameters (delta amplitude and delta phase) can also be encoded differentially based on the links that have been made based on the mono parameters. Further, to provide a scalable bit-stream, the mono parameters may be included in a base layer, whereas the multi-channel parameters are included in an enhancement layer.

In the tracking of the mono components, the cost function (or similarity measure) is a combination of the cost for the frequency, the cost for the amplitude and (optionally) the cost for the phase. For stereo components, the cost function may be a combination of the cost for the common frequency, the cost for the average or maximum amplitude, the cost for the phase, the cost for the delta amplitude and the cost for the delta phase. Alternatively, one may use for the cost function for stereo components: the common frequency, the respective amplitudes and the respective phases.

Advantageously, the sinusoid parameterization using a common frequency and a representation of the respective amplitudes of that frequency in the respective channels is combined with a mono transient parameterization such as disclosed in WO 01/69593-A1 (Applicant's reference PNL000120). This may further be combined with a mono representation for noise such as described in WO 01/88904 (Applicant's reference PHNL000288).

Although most of the embodiments described above relate to two-channel audio signals, the extension to three or more channel audio signals is straightforward.

Addition of an extra channel to an already encoded audio signal can advantageously be done as follows: it suffices to identify in the encoded audio signal that an additional channel is present and to add to the encoded audio signal a representation of the amplitudes of the common frequencies present in the extra channel and a representation of the non-common frequencies. Phase information can optionally be included in the encoded audio signal either.

In a practical embodiment, the average or maximum amplitude and the average phase of the largest amplitude at a common frequency are quantized similar to the respective quantization of the delta amplitude and the delta phase at the common frequency for the other channel(s). Practical values for the quantization are:

| | |
|---|---|
| common frequency | resolution of 0.5% |
| amplitude, delta amplitude | resolution of 1 dB |
| phase, delta phase | resolution of 0.25 rad |

The proposed multi-channel audio encoding provides a reduction of the bit rate when compared to encoding the channels independently.

FIG. 4 shows a system according to an embodiment of the invention. The system comprises an apparatus 1 for transmitting or storing an encoded audio signal [S]. The apparatus 1 comprises an input unit 10 for receiving an at least two-channel audio signal S. The input unit 10 may be an antenna, microphone, network connection, etc. The apparatus 1 further comprises the encoder 11 as shown in FIG. 1 for encoding the audio signal S to obtain an encoded audio signal with a parameterization according to the current invention, e.g. (f_{com}, Aₐᵥ, ΔA) or (f_{com}, Aₘₐₓ, ΔA). The encoded audio signal parameterization is furnished to an output unit 12 which transforms the encoded audio signal in a suitable format [S] for transmission or storage via a transmission medium or storage medium 2. The system further comprises a receiver or reproduction apparatus 3 which receives the encoded audio signal [S] in an input unit 30. The input unit 30 extracts from the encoded audio signal [S] the parameters (f_{com}, Aₐᵥ, ΔA) or (f_{com}, ΔA). These parameters are furnished to a decoder 31 which synthesizes a decoded audio signal based on the received parameters by generating the common frequencies having the respective amplitudes in order to obtain the two channels L and R of the decoded audio signal S′. The two channels L and R are furnished to an output unit 32 that provides the decoded audio signal S′. The output unit 32 may be reproduction unit such as a speaker for reproducing the decoded audio signal S′. The output unit 32 may also be a transmitter for further transmitting the decoded audio signal S′ for example over an in-home network, etc.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. This word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of encoding (11) an at least two-channel audio signal (L,R), the method comprising:
determining (110) common frequencies (f_{com}) in the at least two channels (L,R) of the audio signal, which common frequencies occur in at least two of the at least two channels of the audio signal, and
representing (111) respective sinusoidal components in respective channels at a given common frequency by a representation of the given common frequency (f_{com}) and a representation of respective amplitudes (A,ΔA) of the respective sinusoidal components at the given common frequency.

2. A method of coding as claimed in claim 1, wherein the representation of the respective amplitudes (A,ΔA) comprises an average amplitude (A) and a difference amplitude (ΔA).

3. A method of coding as claimed in claim 1, wherein the representation of the respective amplitudes (A,ΔA) comprises a maximum amplitude (A) and a difference amplitude (ΔA).

4. A method of coding as claimed in claim 1, wherein non-common frequencies are coded as common frequencies, wherein the amplitude representation includes an indication for indicating the at least one channel in which the frequency does not occur.

5. A method of coding as claimed in claim 1, wherein in addition to the common frequencies, non-common frequencies are coded independently.

6. A method as claimed in claim 5, wherein the non-common frequencies are grouped in the coded audio stream in a separate block.

7. A method as claimed in claim 6, wherein the common frequencies are grouped and included in the encoded audio signal preceding to the block of non-common frequencies.

8. A method as claimed in claim 6, wherein the parameters of the sinusoidal components at the common frequencies are included in a base layer and the parameters of the sinusoids at non-common frequencies in an enhancement layer.

9. A method as claimed in claim 1, wherein the method comprises the step of combining respective power or energy representations of the at least two channels to obtain a common representation and wherein the step of determining the common frequencies is performed based on the common representation.

10. A method as claimed in claim 9, wherein the combining step includes adding power spectra of the at least two channels and wherein the common representation is a common power spectrum.

11. A method as claimed in claim 1, wherein frequency and amplitude parameters are included in a base layer and the delta amplitude is included in an enhancement layer.

12. A method as claimed in claim 1, wherein respective phases of the respective sinusoids at the given common frequency are determined and wherein a representation of the respective phases is included in the encoded audio signal.

13. A method as claimed in claim 12, wherein the representation of the respective phases includes an average phase and a difference phase.

14. A method as claimed in claim 12, wherein the representation of the respective phases includes a phase of the channel with a largest amplitude, and a difference phase.

15. A method as claimed in claim 12, wherein the representation of the respective phases is only included in the signal for sinusoids having a frequency up to a given threshold frequency.

16. A method as claimed in claim 15, wherein the given threshold frequency is about 2 kHz.

17. A method as claimed in claim 12, wherein the representation of the respective phases is only included in the signal for sinusoids having an amplitude difference with at least one of the other channels up to a given amplitude threshold.

18. A method as claimed in claim 17, wherein the given amplitude threshold is 10 dB.

19. An encoder (11) for encoding an at least two-channel audio signal (L,R), the encoder comprising:
means (110) for determining common frequencies (f_{com}) in the at least two channels (L,R) of the audio signal, which common frequencies occur in at least two of the at least two channels of the audio signal, and
means (111) for representing respective sinusoidal components in-respective channels at a given common frequency by a representation of the given common frequency (f_{com}) and a representation of respective amplitudes (A,ΔA) of the respective sinusoidal components at the given common frequency.

20. An apparatus (1) for transmitting or recording, the apparatus comprising
an input unit (10) for receiving an at least two-channel (L,R) audio signal (S),
an encoder (11) as claimed in claim 19 for encoding the audio signal (S) to obtain an encoded audio signal ([S]), and
an output unit for providing the encoded audio signal ([S]).

21. An encoded audio signal ([S]) representing an at least two-channel audio signal (L,R), the encoded audio signal comprising:
representations of common frequencies (f_{com}), which common frequencies represent frequencies which occur in at least two of the at least two channels of the audio signal [S], and
for a given common frequency (f_{com}), a representation of respective amplitudes (A,ΔA) representing respective sinusoidal components in respective channels at the given common frequency.

22. A storage medium (2) having stored thereon a signal as claimed in claim 21.

23. A method of decoding (31) an encoded audio signal ([S]), the method comprising:
receiving (31) the encoded audio signal ([S]) representing an at least two-channel audio signal (L,R), the encoded audio signal comprising representations of common frequencies (f_{com}), which common frequencies represent frequencies which occur in at least two of the at least two channels of the audio signal [S], and for a given common frequency (f_{com}), a representation of respective amplitudes (A,ΔA) representing respective sinusoidal components in respective channels at the given common frequency, and
generating (31) the common frequencies at the respective amplitudes in the at least two channels (L,R) to obtain a decoded audio signal (S′).

24. A decoder (31) for decoding an encoded audio signal ([S]), the decoder comprising:
means (31) for receiving the encoded audio signal ([S]) representing an at least two-channel audio signal (L,R), the encoded audio signal comprising representations of common frequencies (f_{com}), which common frequencies represent frequencies which occur in at least two of the at least two channels of the audio signal [S], and for a given common frequency (f_{com}), a representation of respective amplitudes (A,ΔA) representing respective sinusoidal components in respective channels at the given common frequency, and
means (31) for generating the common frequencies at the respective amplitudes in the at least two channels (L,R) to obtain a decoded audio signal (S′).

25. A receiver or reproduction apparatus (3), the apparatus comprising:
an input unit (30) for receiving an encoded audio signal ([S]),
a decoder (31) as claimed in claim 24 to decode the encoded audio signal ([S]) to obtain a decoded audio signal (S), and
an output unit (32) to provide the decoded audio signal (S).
